(19) United States
(12) Patent Application Publication
(10) Pub. No.: US 2008/0151177 A1
(43) Pub. Date: Jun. 26, 2008

(54) Vision-corrective Polarizing Lens

(76) Inventor: Wei Chen Wang, Tainan (TW)

Correspondence Address: Banger Shia, 204 Canyon Creek, Victoria, TX, 77901, US

(21) Appl. No.: 11/615,925

(22) Filed: Dec. 22, 2006

(51) Int. Cl. G02C 7/12

(52) U.S. Cl. 351/49

(57) ABSTRACT

The present invention provides a PC vision-corrective polarizing lens consisted of a polarizing film and an optical substrate, wherein said polarizing film includes protection layer, PVA base and adhesive layer bonding on the surface of the PC optical substrate by injection-molding. The present invention with simple structure and widely adapting to near-sighted lens, far-sighted lens, presbyopia lens and gradual near-sighted lens and so on, not only corrects the poor vision, but also makes the visual object more clear under the cooperating of the polarizing function without visual-tire happened on the eyes.

### BACKGROUND OF THE INVENTION

1. Field of the Invention

The present invention relates to polarizing lens, and more particularly to vision-corrective polarizing lens.

2. Description of Prior Art

As well known, when sunlight shines on object, it is naturally deflected or reflected to generate dazzling light, human eyes can be easy to feel visual-tire under the glaring light. And polarizing lens can make all the sunlight including reflected or multi-deflected rays transmit the lens in uniform direction, so by the filter of said polarizing lens, the glaring light can be reduced in the eye sight, especially to the reflected light, the dazzling light, the deflected light and so on, and the visual distance can be extended, especially to the drivers of vehicles, a wide and clear visual field can be presented by using the polarizing lens.

In accordance with the conventional polarizing lens, as shown in FIG. 1, it is typically cohered of a polarizing film 1′, adhesion agent 2′ and a substrate 3′ together, due to the limited bonding force of the common adhesion agent 2′, said polarizing film 1′ bonded on the substrate 3′ by the adhesion agent 2′ rests on a poor adhesiveness, so it is apt to blister air bulbs, to separate, even to split and so on bad phenomena, further to directly affect the optical performance of the lens, so the polarizing film technology has not been applied widely on manufacturing various lens, especially to the optical lens. But, the optical lens such like near-sighted lens, far-sighted lens, presbyopia lens and gradual near-sighted lens and so on, are used for correcting poor vision, as regards the poor visual eyes, the reflected light, the blazing light, the deflected light and so on are very sensitized, so these glaring lights not only are unfavorable to the vision correction, but also speed up the poor vision decaying, therefore come to the conclusion that the optical lens needs to increase polarizing function urgently for clearing visual field and avoiding eye vision-tiring. So the inventor developed a PC (polycarbonate resin) vision-corrective polarizing lens.

### OBJECTS AND SUMMARY OF THE INVENTION

It is therefore a main object of the present invention to provide a vision-corrective polarizing lens that has simple structure, and adapts to manufacturing various optical substrate, not only guarantee optical performance, but also add polarizing function to the optical substrate.

For archiving the goal, the present invention provides a vision-corrective polarizing lens, which is typically consisted of a PC optical substrate and a polarizing film, wherein said polarizing film includes protection layer, PVA (polyvinyl alcohol drawn film) base and adhesive layer bonding on the surface of the PC optical substrate by injection-molding, therein by said adhesive layer said polarizing film is bonded on the PC optical substrate together.

Said protection layer is a TAC (acetate film) layer, and said adhesive layer is PC layer as same as the PC optical substrate.

Said protection layer is a PET (polyethylene film) layer, and said adhesive layer is PET layer too.

Said protection layer is a PMMA (polymethylmethacrylate film) layer, and said adhesive layer is PMMA layer too.

Said protection layer is a TAC (acetate film) layer, and said adhesive layer is PC layer, and a TAC layer is sandwiched between the PVA base and the PC layer for protecting the PVA base.

Said polarizing film is bond on the outside surface of said PC optical substrate.

Said polarizing film is bond on the inside surface of said PC optical substrate.

Due to applying above-mentioned structure, the present invention substitutes the adhesive layer for the conventional adhesion agent, so that said adhesive layer can be bonded on the PC optical substrate by injection-molding to carry out bonding different objects together in bonding the polarizing film and the PC optical substrate with simple structure and high adhesive strength without blistering, separating, splitting and so on bad phenomena, in this case, the rate of good productive is kept in high level, it not only guarantees optical performance, but also adds polarizing function to the optical lens, therefore the present invention can be applied widely on manufacturing various lens, especially to the optical lens, such like near-sighted lens, far-sighted lens, presbyopia lens and gradual near-sighted lens and so on, to make these optical lens not only correct the poor vision, but also to make the visual object more clear without visual-tire happened on the eyes.

### BRIEF DESCRIPTION OF THE DRAWINGS

FIG. 1 is a sectional view showing the sectional structure of the prior art.

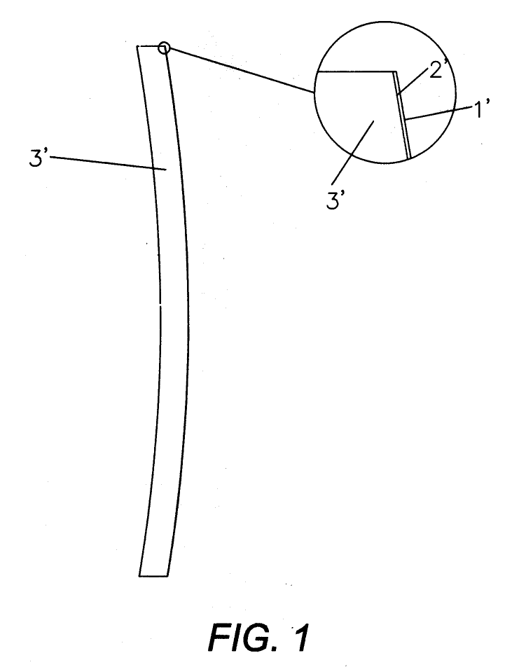

FIG. 2 is a sectional view showing the first structure of the present invention.

FIG. 3 is a sectional view showing the second structure of the present invention.

### DETAILED DESCRIPTION OF PREFERRED EMBODIMENTS

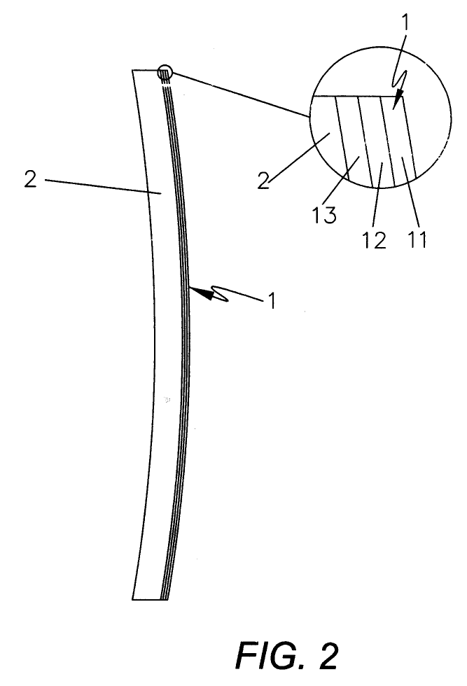

Referring to FIG. 2, a PC vision-corrective polarizing lens provided of the present invention is consisted of a polarizing film 1 and a PC optical substrate 2.

Said polarizing film 1 typically includes protection layer 11, PVA base 12 and adhesive layer 13.

Wherein, said adhesive layer 13 can be bonded on the surface of the PC optical substrate 2 by injection-molding, the materials of said protection layer 11 and said adhesive layer 13 have following choices:

In the first embodiment, said protection layer 11 is a TAC layer, and said adhesive layer 13 is PC layer as same as the PC optical substrate, as such the PC optical lens is consisted of four layers including three-layer polarizing film 1 comprised of TAC layer, PVA base and PC layer.

In the second embodiment, said protection layer 11 is a PET layer, and said adhesive layer 13 is PET layer too, as such the polarizing film 1 is structured of PET layer, PVA base and PET layer, so the whole PC vision-corrective optical lens includes four layers.

In the third embodiment, said protection layer 11 is a PMMA layer, and said adhesive layer 13 is PMMA layer bonding on the PC optical substrate 2, as such the polarizing film 1 is structured of PMMA layer, PVA base and PMMA layer, so the whole PC vision-corrective optical lens includes four layers.

Of course, said protection layer 11 and said adhesive layer 13 also can use other either same or different materials.

Said polarizing film 1 is bonded on the PC optical substrate 2 by said adhesive layer 13 together to construct the PC vision-corrective polarizing lens.

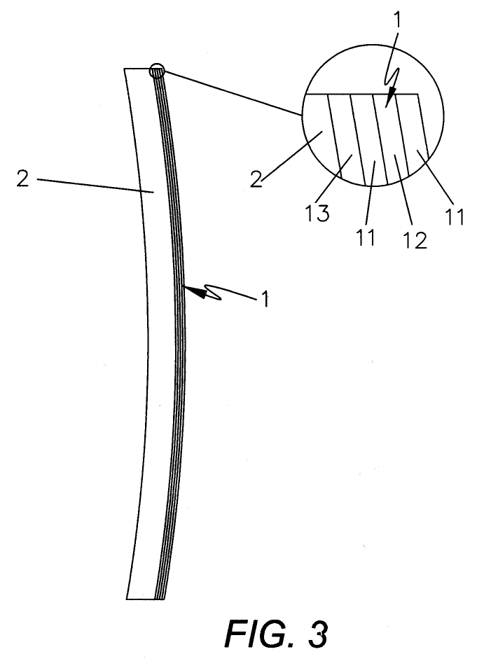

Referring to FIG. 3 again, the present invention also offers a protection layer 11 between the PVA base 12 and the adhesive layer 13 for protecting the PVA base 12, specifically, in the fourth embodiment, said protection layer 11 is a TAC layer, and said adhesive layer 13 is PC layer, and a TAC layer (a protection layer 13) is sandwiched between the PVA base 12 and the PC layer (a adhesive layer 13), as such the polarizing film 1 is structured of TAC layer, PVA base, and PET layer, TAC layer and PC layer four layers, so the whole PC vision-corrective optical lens has five layers.

It should be declared that said polarizing film 1 can be bonded on the outside surface of the PC optical substrate 2, as shown in FIG. 2 and FIG. 3, it also can be bonded on the inside surface of the PC optical substrate 2 (not shown in drawings).

In this way, the PC vision-corrective polarizing lens discovered by the present invention, widely adapting to near-sighted lens, far-sighted lens, presbyopia lens and gradual near-sighted lens and so on, not only corrects the poor vision, but also makes the visual object more clear under the cooperating of the polarizing function without visual-tire happened on the eyes.

I claim:

1. A PC vision-corrective polarizing lens consisted of a polarizing film and an optical substrate, wherein said polarizing film includes protection layer, PVA base and adhesive layer bonding on the surface of the PC optical substrate by injection-molding.

2. A PC vision-corrective polarizing lens as claimed in claim 1, wherein said protection layer is a TAC layer, and said adhesive layer is PC layer as same as the PC optical substrate.

3. A PC vision-corrective polarizing lens as claimed in claim 1, wherein said protection layer is a PET layer, and said adhesive layer is PET layer too.

4. A PC vision-corrective polarizing lens as claimed in claim 1, wherein said protection layer is a PMMA layer, and said adhesive layer is PMMA layer too.

5. A PC vision-corrective polarizing lens as claimed in claim 1, wherein said protection layer is a TAC layer, and said adhesive layer is PC layer, and a TAC layer is sandwiched between the PVA base and the PC layer for protecting the PVA base.

6. A PC vision-corrective polarizing lens as claimed in claim 1, wherein said polarizing film is bond on the outside surface of said PC optical substrate.

7. A PC vision-corrective polarizing lens as claimed in claim 1, wherein said polarizing film is bond on the inside surface of said PC optical substrate.
